(19) United States
(12) Patent Application Publication
(10) Pub. No.: US 2025/0054380 A1
(43) Pub. Date: Feb. 13, 2025

(54) SYSTEM AND METHOD FOR REMOTELY MONITORING LIGHT BEACON STATUS OF A MACHINE

(71) Applicant: Daniel Ira West, San Diego, CA (US)

(72) Inventor: Daniel Ira West, San Diego, CA (US)

(21) Appl. No.: 18/448,104

(22) Filed: Aug. 10, 2023

(51) Int. Cl. G08B 21/18

(52) U.S. Cl. CPC G08B 21/18

(57) ABSTRACT

A system and a method are provided for monitoring the status of at least one light beacon of at least one machine. An enclosure containing a light detector circuit is installed on the at least one machine to detect light signals emanating from the at least one light beacon. A micro-controller is configured in communication with the light detector circuit to receive the detected light signals via a communication network. A server device is communicably connected to the micro-controller to receive the detected light signals from the enclosure. The server device is configured to operate a computer-executable application via the communication network to thereby analyse and record the status of at least one light beacon.

### TECHNICAL FIELD

The present invention generally relates to the field of monitoring of Computerised Numerical Control (CNC) machines. More particularly, the invention relates to a system and method for monitoring the status of light beacon(s) of CNC machines.

### BACKGROUND

This section presents a description of the related art to provide background information relating to the field of the disclosure. This description as disclosed in this section may contain some aspects of the art that may be related to various features of the present disclosure. However, the purpose of the description is only to enhance the understanding of the reader with respect to the present disclosure, and not admissions of the prior art.

In the current era, industrial systems are evolving and expanding with increasing complexities. A CNC machine (or a computerized numerical control machine) is one of such complex machines, that is used for manufacturing various devices, articles, and components by using various controlled processes. A CNC machine executes a plurality of programs corresponding to different processes. Typically, a plurality of CNC machines may be used in a workshop to improve manufacturing yields. However, monitoring the working states of all these CNC machines is complex and difficult. Often, a person is assigned a job to monitor the status of these machines by watching the light beacons on the machines. Traditionally, the beacon lights glowing in a particular colour, such as ‘green’, indicates the smooth functioning of the CNC machines. On the contrary, if the beacon light fluctuates or does not glow, then it indicates that there is some fault in the machine that needs to be promptly addressed.

However, one cannot always see the machine's light beacon to know the machine's running status. There is required a novel method and system to automatically determine whether a CNC machine is running or has completed the machining task and is waiting for the next operation.

### SUMMARY

In order to provide a holistic solution to the above-mentioned limitations, there is provided automated system and method for facilitating remote monitoring of multiple machines from a single source or device.

Accordingly, the object of the present invention is to provide an automated system and method for facilitating remote monitoring of multiple machines from a single source or device capable of remotely communicating with each of the multiple machines.

According to an embodiment of the present disclosure, there is provided a system for A system for monitoring status of at least one light beacon of at least one machine, the system comprising: an enclosure communicably connected to the at least one light beacon, the enclosure containing: a light detector circuit to detect light signals emanating from the at least one light beacon; a micro-controller configured in communication with the light detector circuit to receive the detected light signals and thereafter send the detected light signals via a wireless communication port to a server; the server, communicably connected to the micro-controller via a communication network to receive the detected light signals, and configured to operate a computer-executable application to thereby analyse and record the status of at least one light beacon; and a user device configured to receive from the server, a notification alert based on the status of the at least one light beacon.

According to an embodiment of the present disclosure, the light detector circuit uses a light sensor component to detect the light emanating from the at least one light beacon, the light sensor includes photovoltaic light sensors, photodiodes, photoresistors, and phototransistors.

According to an embodiment of the present disclosure, the enclosure is attached to the at least one machine by using a fastening means.

According to an embodiment of the present disclosure, the micro-controller is configured by setting up one or more parameters including network connection information, CNC machine ID, passwords, displays, and an initial status of the at least one light beacon of the at least one machine.

According to an embodiment of the present disclosure, the status of at least one light beacon is monitored remotely in real-time.

According to an embodiment of the present disclosure, the status of at least one light is recorded as data logging that can be read back by plotting a data chart that can be further analyzed for machine production efficacy at a given production facility.

According to an embodiment of the present disclosure, the enclosure is installed on the at least one machine by using a non-invasive mechanism.

According to an embodiment of the present disclosure, the system further comprises at least one external light sensor connected to the micro-controller by using an external cable that is inserted into a connecting port provided on at least one side of the enclosure.

According to an embodiment of the present disclosure, a method for monitoring the status of at least one light beacon of at least one machine is disclosed. The method comprises installing an enclosure on the at least one machine, the enclosure containing a light detector circuit to detect light signals emanating from the at least one light beacon: configuring a micro-controller configured in communication with the light detector circuit to receive the detected light signals and thereafter send the detected light signals via a wireless communication port to a server; communicably connecting the server to the micro-controller via a communication network to receive the detected light signals; configuring the server to operate a computer-executable application to thereby analyse the detected light signals to subsequently record the status of at least one light beacon; and configuring a user device configured to receive from the server, a notification alert based on the status of the at least one light beacon.

The aforementioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present invention, and is therefore, not intended to define key features or scope of the subject matter of the present invention.

### BRIEF DESCRIPTION OF THE DRAWINGS

The figures mentioned in this section are intended to disclose exemplary embodiments of the claimed system and method. Further, the components/modules and steps of a process are assigned reference numerals that are used throughout the description to indicate the respective components and steps. Other objects, features, and advantages of the present invention will be apparent from the following description when read with reference to the accompanying drawings.

FIG. 1 illustrates a system architecture diagram, in accordance with an exemplary embodiment of the present invention.

FIG. 1a illustrates a system architecture diagram, in accordance with another exemplary embodiment of the present invention.

FIG. 2 illustrates the enclosure having a display screen, in accordance with an exemplary embodiment of the present invention.

FIG. 3 shows a screenshot of a machine setup, in accordance with an exemplary embodiment of the present invention.

FIG. 4 shows a list of all machines and their status, in accordance with an exemplary embodiment of the present invention.

FIG. 5 shows log data of a machine, in accordance with an exemplary embodiment of the present invention.

FIG. 6 illustrates a method for monitoring the status of at least one light beacon of at least one machine, in accordance with exemplary embodiments of the present invention.

### DETAILED DESCRIPTION

This section is intended to provide explanation and description of various possible embodiments of the present invention. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings.

The present disclosure relates to a system and a method for monitoring status of at least one light beacon of at least one machine. An enclosure containing a light detector circuit is installed on the at least one machine to detect light signals emanating from the at least one light beacon. A micro-controller is provided in communication with the light detector circuit to receive the detected light signals via a communication network. A server device is communicably connected to the micro-controller to receive the detected light signals from the micro-controller. The server device is configured to operate a computer-executable application via the communication network to thereby analyse and record the status of at least one light beacon.

As used herein, ‘user device’ is a smart electronic device capable of communicating with various other electronic devices and applications via one or more communication networks. Examples of said user device include, but not limited to, a wireless communication device, a smart phone, a tablet, a desktop, a laptop, a computer system etcetera. The user device comprises: an input unit to receive one or more input data; an operating system to enable the computer device to operate; a processor to process various data and information; a memory unit to store initial data, intermediary data and final data; and an output unit. The processor associated with the computer device is an intelligent device or module, that is specifically programmed to process digital logics and perform analytical skills for analysing and processing various data and metadata or information, according to the embodiments of the present invention. The processor may be programmed by using executable instructions stored in the memory.

As used herein, ‘module’ or ‘unit’ refers to a device, a system, a hardware, a computer application, a framework, configured to execute specific functions or instructions according to the embodiments of the present invention. The module or unit may include a single device or multiple devices configured to perform specific functions according to the present invention disclosed herein.

As used herein, a “micro-controller” is a processing unit and includes one or more processors, microprocessors, microcomputers, micro-controllers, digital signal processors, central processing units, state machines, logic circuitries, and/or any devices that manipulate signals based on operational instructions. The processing unit may also refer to any logic circuitry for processing instructions. Among other capabilities, the processing unit may be configured to fetch and execute computer-readable instructions stored in the memory. More specifically, the processor or processing unit is a hardware processor.

As used herein, “storage unit” or “memory unit” refers to a machine or computer-readable medium including any mechanism for storing information in a form readable by a computer or similar machine. The computer-readable medium may include a volatile memory, such as static random-access memory (SRAM) and dynamic random-access memory (DRAM), and/or non-volatile memory, such as read only memory (ROM), erasable programmable ROM, flash memories, hard disks, optical disks, magnetic tapes and/or other types of machine-accessible storage media. The storage unit stores at least the data that may be required by one or more units of the system to perform their respective functions.

As used herein, an ‘application’ may be a software package installed on an electronic device/user device, that performs one or more functions for an end user of the electronic device and/or for another application installed on the electronic device.

As used herein, ‘network’ or ‘communication network’ including but not limited to a local area network (LAN), a wide area network (WAN), a metropolitan area network (MAN), a virtual private network (VPN), an enterprise private network (EPN), Internet, and a global area network (GAN).

Terms such as ‘connect’, ‘couple’ and other similar terms include a physical connection, a wired connection, a wireless connection, a logical connection or a combination of such connections including electrical, optical, RF, infrared, Bluetooth, Wi-Fi, or other transmission media, as may be obvious to a person skilled in the art.

Terms such as ‘send’, ‘transfer’, ‘transmit’ and ‘receive’, ‘collect’, ‘obtain’ and other similar terms refer to transactions of data between various modules and units via wired or wireless connections.

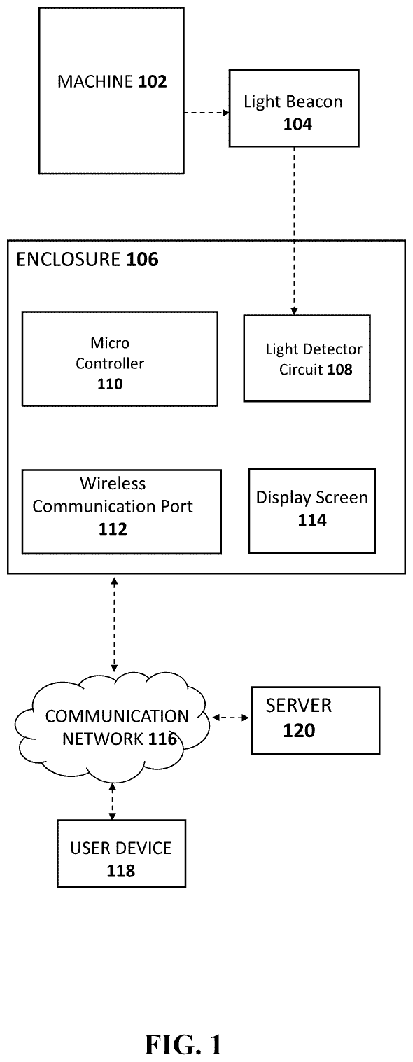

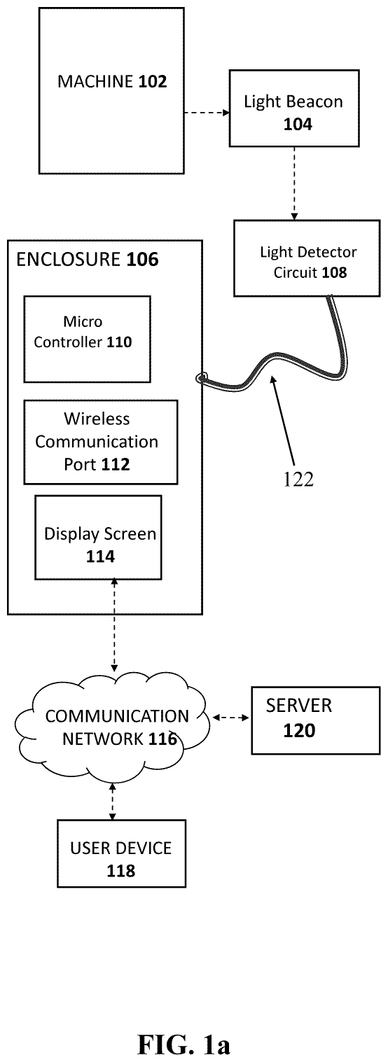

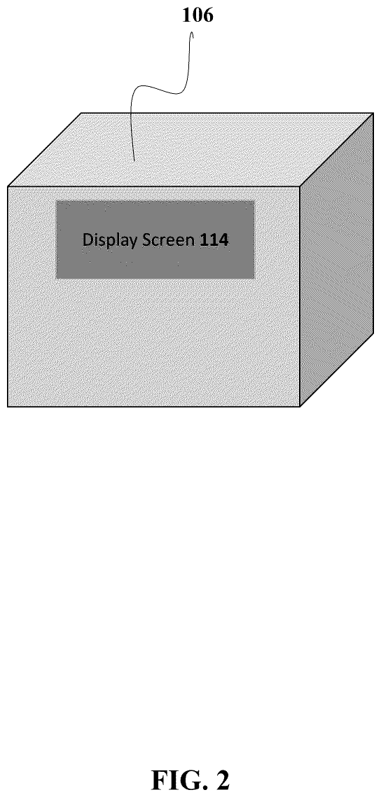

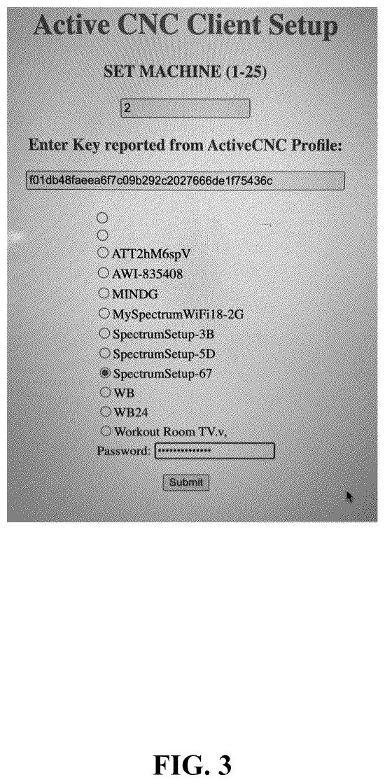

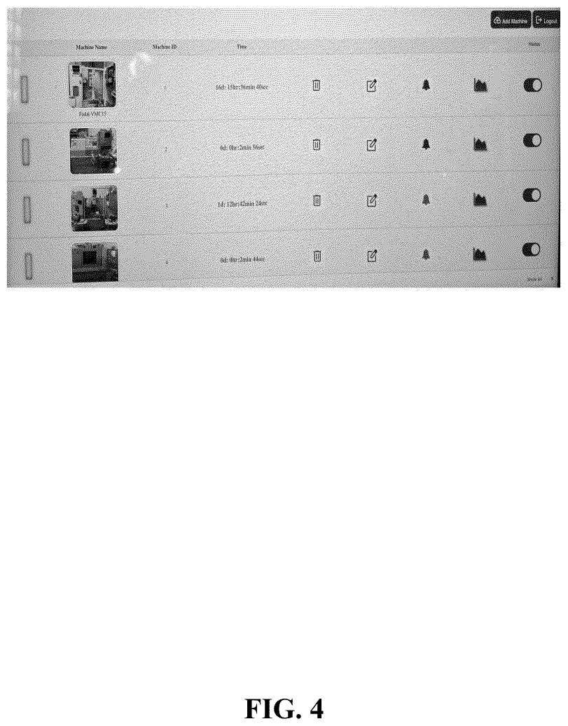

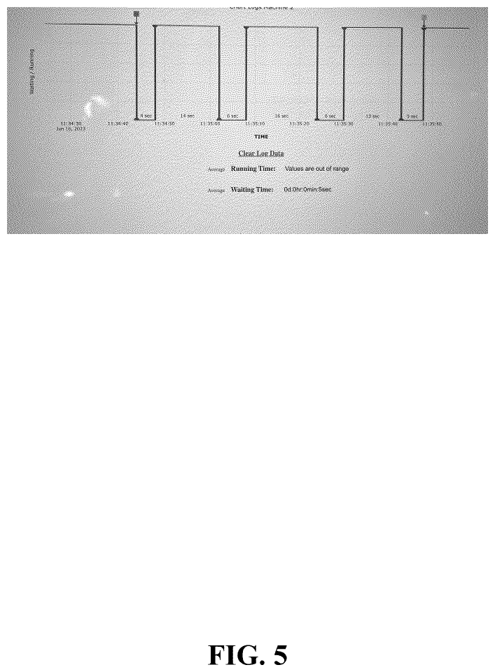

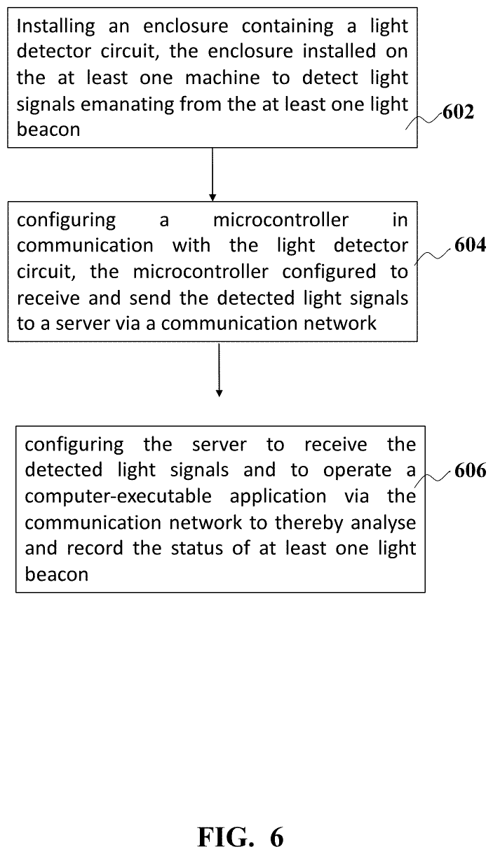

FIG. 1 illustrates a system architecture diagram, in accordance with exemplary embodiments of the present invention. FIG. 1a illustrates a system architecture diagram, in accordance with another exemplary embodiment of the present invention. FIG. 2 illustrates the enclosure having a display screen, in accordance with an exemplary embodiment of the present invention. FIG. 3 shows a screenshot of a machine setup, in accordance with an exemplary embodiment of the present invention. FIG. 4 shows a list of all machines and their status, in accordance with an exemplary embodiment of the present invention. FIG. 5 shows log data of a machine, in accordance with an exemplary embodiment of the present invention. FIG. 6 illustrates a method for monitoring the status of at least one light beacon of at least one machine, in accordance with exemplary embodiments of the present invention.

Referring now to FIG. 1 through FIG. 5, the system for monitoring the status of at least one light beacon 104 of at least one machine 102 comprises an enclosure 106 having four side walls, a bottom or a base and a top cover. The enclosure 106 adapts a light detector circuit 108 to detect light signals of the machine 102. The machine 102 includes one or more manufacturing machines, control machines, Computerised Numerical Control (CNC) machines or any other machines that perform various operations for manufacturing different products, components and devices or used in control systems. The enclosure 106 is installed on the at least one machine 102 to detect light signals emanating from the at least one light beacon 104. The enclosure 106 is attached to the at least one machine 102 by using any fastening means that is external to the machine 102. The fastening means may include devices like Velcro straps, adhesive tapes, fasteners etcetera. The wireless communication port 112 is also provided to enable the communication between the micro-controller 110, user device 118 and server 120.

The enclosure 106 is communicably connected to the at least one light beacon 104. The enclosure 106 contains a light detector circuit 108 to detect light signals emanating from the at least one light beacon 104. A micro-controller 110 is also configured in communication with the light detector circuit 108 to receive the detected light signals and thereafter send the detected light signals via the wireless communication port 112 to the server 120. The machine 102 need not be opened to connect the light detector circuit 108. This allows a user to install the light detector circuit 108 without using any invasive mechanism. In one embodiment of the present invention, the enclosure 106 may accordingly be installed on the machines by using a non-invasive mechanism such as by using fastening means like a Velcro strap, tape, clamp or any other binding means, etc. Thus, there is no need to make any invasive electrical wiring internal to the CNC machine's light-beacon circuitry.

The system for monitoring status of at least one light beacon 104 of at least one machine 102 also comprises a server 120 that is communicably connected to the micro-controller 110 via a communication network 116 to receive the detected light signals. The server 120 is configured to operate a computer-executable application to thereby enable the analysis and recording of the status of at least one light beacon 104. Further, the user device 118 is configured to receive from the server 120, a notification alert based on the status of the at least one light beacon 104. The status of at least one light beacon 104 is monitored remotely in real-time. In various embodiments of the present invention, the status of at least one light is recorded as data logging that can be read back by plotting a data chart that can be further analyzed for machine production efficacy at a given production facility.

The light detector circuit 108 uses a light sensor component to detect the light emanating from the at least one light beacon 104. The light sensor includes photovoltaic light sensors, photodiodes, photoresistors, and phototransistors. Further, the micro-controller 110 is configured by setting up one or more parameters including network connection information, CNC machine ID, passwords, displays, and an initial status of the at least one light beacon 104 of the at least one machine 102. As shown in FIG. 2, there is provided a screen 114 on one of the side walls of the enclosure 106 to display necessary information to the user. The setup process of the machine 102 is shown in FIG. 3 wherein an initial device setup is run on the user device 118 by entering information pertaining to the at least one machine number/unique ID, and local Wi-Fi router information. Other information such as web browser Wi-Fi source credential is entered by selecting name of one of the available Wi-Fi routers. Once the router is selected, IP address is displayed on the display screen 114 of the enclosure 106. Subsequently, information pertaining to the machine ID, key provided, name of local Wi-Fi router and password are entered to setup the machine 102 in sync with the enclosure 106.

In one embodiment of the present disclosure, and as shown in FIG. 1a, the system comprises at least one external light sensors connected to the micro-controller 110 by using an external cable 122 that is inserted into a connecting port provided on at least one side wall of the enclosure 106.

Once the light detector circuit 108 is installed internal to the enclosure 106, or externally, the status of at least one light beacon 104 may be monitored remotely in real-time. Securing the light detector circuit 108 inside the enclosure 106 provide safety and compactness to the device and also avoids any interference to the signals being captured by the light detector circuit 108. On the other hand, the external light detector circuit 108 provides flexibility to the user to reach to the machines that are installed far-away. When the enclosure 106 is away from the machine 102 and light beacon 104, a wired extension or cable 122 may be used to run the light sensor to the light beacon 104, as shown in FIG. 1a. According to an embodiment of the present disclosure, the light detector circuit 108 uses a photovoltaic component to detect the light emanating from the at least one light beacon 104 of the at least one CNC machine 102.

The micro-controller 110 is configured in communication with the light detector circuit 108. The micro-controller 110 is configured to receive the detected light signals via a wireless communication port 112. The micro-controller 110 is configured by setting up one or more parameters including network connection information, CNC machine ID, passwords, displays, and initial status of the at least one light beacon 104 of the at least one CNC machine 102.

Further, a server device 120 is communicably connected to the enclosure 106 to receive the detected light signals from the micro-controller 110, the server device 120 is configured to operate a computer-executable application 104 via the communication network 116 to thereby analyse and record the status of at least one light beacon 104. Further, the status of at least one light beacon 104 is recorded as data logging that can be read back by plotting a data chart that can be further analysed for machine production efficacy at a given production facility. The computer-executable application 104 may be a web-based application or a mobile application or ‘an app’ to be operated using smart electronic devices.

FIG. 6 illustrates a method for monitoring the status of at least one light beacon 104 of at least one Computerised Numerical Control machine 102 (CNC machine), in accordance with exemplary embodiments of the present invention. The structural elements of the server 120 and the micro-controller 110, to implement the method, may include input units, output units, processing units and memory devices. Other structural elements essential for performing these method steps have been described in detail in description of FIG. 1 through FIG. 2. Given below are the steps of the method according to the embodiments of the present subject matter.

At step 602, the enclosure 106 containing the light detector circuit 108 may be installed. The enclosure 106 is non-invasively installed on the at least one machine 102, and may accommodate or externally connect the light detector circuit 108 to detect light signals emanating from the at least one light beacon 104.

At step 604, configuration of the micro-controller 110 in communication with the light detector circuit 108 is performed to receive the detected light signals and thereafter send the detected light signals via a wireless communication port to a server 120.

At step 606, configuration of the server device 120 is performed. The server device 120 is communicably connected to the micro-controller 110 via the communication network 116 to receive the detected light signals. The server is configured to operate a computer-executable application to thereby analyse the detected light signals to subsequently record the status of at least one light beacon 104. Also, the user device 118 may be configured to receive from the server, a notification alert based on the status of the at least one light beacon 104.

According to an embodiment of the present disclosure, the at least one beacon 104 can also be termed as a ‘machine light-beacon’. Most CNC machines used in the manufacturing and fabrication of metal, plastic parts, and electronic components, have an attached light beacon to indicate the state of “waiting” for the next operation task. A flashing green or blue beacon light commonly indicates a machine 102 has completed an operation and is waiting for the next operation. A stable blue or green light typically indicates the machine 102 is in the running, or operating state. Further, each machine 102 is given a number determined by the person setting up the system. At this time, there is no set limit to the number of machines 102 that can be monitored.

Although the subject matter is described in language specific to structural features and/or acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

1. A system for monitoring status of at least one light beacon of at least one machine, the system comprising:
an enclosure communicably connected to the at least one light beacon, the enclosure containing:
a light detector circuit to detect light signals emanating from the at least one light beacon;
a micro-controller configured in communication with the light detector circuit to receive the detected light signals and thereafter send the detected light signals via a wireless communication port to a server;
the server, communicably connected to the micro-controller via a communication network to receive the detected light signals, and configured to operate a computer-executable application to thereby analyse and record the status of at least one light beacon; and
a user device configured to receive from the server, a notification alert based on the status of the at least one light beacon.

2. The system as in claim 1, wherein the light detector circuit uses a light sensor component to detect the light emanating from the at least one light beacon, the light sensor includes photovoltaic light sensors, photodiodes, photoresistors, and phototransistors.

3. The system as in claim 1, wherein the enclosure is attached to the at least one machine by using a fastening means.

4. The system as in claim 1, wherein the micro-controller is configured by setting up one or more parameters including network connection information, CNC machine ID, passwords, displays, and an initial status of the at least one light beacon of the at least one machine.

5. The system as in claim 1, wherein the status of at least one light beacon is monitored remotely in real-time.

6. The system as in claim 1, wherein the status of at least one light is recorded as data logging that can be read back by plotting a data chart that can be further analyzed for machine production efficacy at a given production facility.

7. The system as in claim 1, wherein the enclosure is installed on the at least one machine by using a non-invasive mechanism.

8. The system as in claim 1, further comprising at least one external light sensors connected to the micro-controller by using an external cable that is inserted into a connecting port provided on at least one side of the enclosure.

9. A method for monitoring the status of at least one light beacon of at least one machine, the method comprising:
installing an enclosure on the at least one machine, the enclosure containing a light detector circuit to detect light signals emanating from the at least one light beacon:
configuring a micro-controller configured in communication with the light detector circuit to receive the detected light signals and thereafter send the detected light signals via a wireless communication port to a server;
communicably connecting the server to the micro-controller via a communication network to receive the detected light signals;
configuring the server to operate a computer-executable application to thereby analyse the detected light signals to subsequently record the status of at least one light beacon; and
configuring a user device configured to receive from the server, a notification alert based on the status of the at least one light beacon.

10. The method as in claim 9, wherein the light detector circuit uses a uses a light sensor component to detect the light emanating from the at least one light beacon, the light sensor includes photovoltaic light sensors, photodiodes, photoresistors, and phototransistors.

11. The method as in claim 9, wherein the enclosure is attached to the at least one machine by using a fastening means.

12. The method as in claim 9, wherein the micro-controller is configured by setting up one or more parameters including network connection information, CNC machine ID, passwords, displays, and an initial status of the at least one light beacon of the at least one machine.

13. The method as in claim 9, wherein the status of at least one light beacon is monitored remotely in real-time.

14. The method as in claim 9, wherein the status of at least one light is recorded as data logging that can be read back by plotting a data chart that can be further analyzed for machine production efficacy at a given production facility.

15. The method as in claim 9, wherein the enclosure is installed on the at least one machine by using a non-invasive mechanism.

16. The method as in claim 9, further comprising at least one external light sensors connected to the micro-controller by using an external cable that is inserted into a connecting port provided on at least one side of the enclosure.
